(19) United States
(12) Patent Application Publication
(10) Pub. No.: US 2005/0212973 A1
(43) Pub. Date: Sep. 29, 2005

(54) Video display apparatus

(75) Inventor: Kazunori Yamate, Ibaraki-shi (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO.,LTD., Osaka 571-8501 (JP)

(21) Appl. No.: 10/509,680

(22) PCT Filed: Apr. 14, 2003
(86) PCT No.: PCT/JP03/04724

§ 371 Date: Oct. 12, 2004

(30) Foreign Application Priority Data
Apr. 17, 2002 (JP) 2002-114563
Feb. 4, 2003 (JP) 2003-26738
Apr. 10, 2003 (JP) 2003-105948

(51) Int. Cl. H04N 5/21

(52) U.S. Cl. 348/626

(57) ABSTRACT

A video display apparatus comprises a luminance signal processing circuit, a color-difference signal processing circuit, an RGB matrix circuit, a CRT drive circuit, a plurality of VM coils, a plurality of scanning-speed modulation circuit blocks, a horizontal deflection circuit, a vertical deflection circuit, a horizontal deflection coil, and a vertical deflection coil. An electron beam emitted inside the CRT by the CRT drive circuit is scanned horizontally and vertically by the horizontal deflection coil and the vertical deflection coil. Velocity modulation currents are supplied to the plurality of VM coils by the plurality of scanning-speed modulation circuit blocks. This results in the generation of velocity modulation magnetic fields from the plurality of VM coils, thereby partially modulating the velocity of the horizontally scanned electron beam.

### TECHNICAL FIELD

The present invention relates to a video display apparatus having a function of correcting the contour of an image.

### BACKGROUND ART

Conventionally, there has been a video display apparatus in which the scanning speed of an electron beam is modulated for correcting the contour of an image displayed on a cathode ray tube (hereinafter abbreviated to CRT) or the like. As such a video display apparatus, JP 1-29173 A, for example, proposes a signal generation circuit for velocity modulation.

FIG. 12 is a block diagram showing the configuration of the velocity modulation signal generation circuit, and FIG. 13 is a schematic diagram showing the shape and configuration of the velocity modulation coil shown in FIG. 12. In addition, FIG. 14 is a waveform diagram for explaining the operation of the velocity modulation signal generation circuit shown in FIG. 12.

The velocity modulation signal generation circuit 70 shown in FIG. 12 comprises a luminance signal processing circuit 71, a color-difference signal processing circuit 72, an RGB matrix circuit 73, a CRT drive circuit 74, a phase corrector circuit 76, a differentiation circuit 77, a velocity modulation (hereinafter abbreviated to VM) drive circuit 78, a CRT 75, and a velocity modulation (VM) coil 79.

As shown in FIG. 13(a), a plurality of coils are connected in series in the VM coil 79. The VM coil 79 can be represented by an equivalent circuit, as shown in FIG. 13 (b). Although each of the coils is shown to have one turn in FIG. 13(a), each coil has, in general, several turns. The VM coil 79 is supplied with a velocity modulation current VMI described later.

The luminance signal processing circuit 71 and the color-difference signal processing circuit 72 each have a delay circuit (not shown).

In the velocity modulation signal generation circuit 70 shown in FIG. 12, a luminance signal Y is input to the luminance signal processing circuit 71, while a color-difference signal C is input to the color-difference processing circuit 72.

The luminance signal Y input to the luminance signal processing circuit 71 is delayed for a predetermined period of time while being processed for correction of an image, and the processed luminance signal Y is applied to the RGB matrix circuit 73. FIG. 14(a) shows one example of the waveform of the processed luminance signal Y.

The color-difference signal C is delayed for a predetermined period of time while being processed for correction of an image, and the processed color-difference signal C is applied to the RGB matrix circuit 73.

In the RGB matrix circuit 73, primary color signals, ER, EG, EB corresponding to the respective luminances of red, green, and blue are generated based on the luminance signal Y and color-difference signal C. Each of the generated primary color signals ER, EG, EB is applied to the CRT drive circuit 74.

In the CRT drive circuit 74, the primary color signals ER, EG, EB applied by the RGB matrix circuit 73 are amplified. FIG. 14(b) shows one example of the waveform of the primary color signal ER. In the CRT 75, an electron beam based on the primary color signals ER, EG, EB is emitted.

The electron beam is scanned horizontally and vertically on the screen of CRT 75 by means of a horizontal deflection magnetic field and a vertical deflection magnetic field generated by a horizontal deflection coil and a vertical deflection coil, respectively (not shown). This allows displaying of an image on the screen of CRT 75.

Moreover, the luminance signal Y input to the luminance signal processing circuit 71 (FIG. 14(a)) is processed for correction of an image, and also applied to the phase corrector circuit 76. In the phase corrector circuit 76, the phase of the luminance signal Y is corrected. The corrected luminance signal Y is applied to the differentiation circuit 77.

In the differentiation circuit 77, the luminance signal Y is first-order differentiated to generate a velocity modulation signal. The generated velocity modulation signal is applied to the VM drive circuit 78.

In the VM drive circuit 78, a velocity modulation current VMI is output based on the velocity modulation signal generated by the differentiation circuit 77. FIG. 14(c) shows one example of the waveform of the velocity modulation current VMI.

As shown in FIG. 14(b), (c), the delay time of the luminance signal Y in the luminance signal processing circuit 71 and the delay time of the color difference signal C in the color-difference processing circuit 72 are set so that a rising edge and a falling edge of the primary color signal ER correspond to a peak position and a bottom position of the velocity modulation current VMI, respectively.

The velocity modulation current VMI output from the VM drive circuit 78 is supplied to the VM coil 79. This causes generation of a velocity modulation magnetic field from the VM coil 79.

FIG. 14(d) shows a magnetic field MT obtained by synthesizing the horizontal deflection magnetic field generated by the horizontal deflection coil (not shown) and the velocity modulation magnetic field generated by the VM coil 79 based on the velocity modulation current VMI shown in FIG. 14(c).

As seen from FIG. 14(d), the horizontal deflection magnetic field generated by the horizontal deflection coil changes partially at points P and Q, corresponding to the velocity modulation current VMI shown in FIG. 14(c). This allows the horizontal scanning speed of an electron beam to be partially modulated.

As a result, the luminance distribution on the screen of CRT 75 abruptly changes according to the changes of the luminance signal Y, so that contour correction for an image is provided. FIG. 14(e) shows a luminance distribution LU on the screen of the CRT 75 in this case.

The horizontal scanning speed of an electron beam is modulated as in the above, so that the display of a precise contour is realized.

By the way, since in the velocity modulation signal generation circuit 70 shown in FIG. 12 the velocity modulation signal is obtained by the first-order differentiation of the luminance signal Y, the velocity modulation signal has very abrupt rising and falling edges. In other words, the velocity modulation signal has a high frequency component.

Because of the frequency characteristic of the VM drive circuit 78, however, the VM drive circuit 78 can follow limited frequencies of the velocity modulation signal, as will now be described. Normally, the VM drive circuit 78 can follow only up to about several MHz.

Here, assuming that L is the inductance of the VM coil 79; I is the current value of the velocity modulation current VMI supplied to the VM coil 79; and f is the frequency of the velocity modulation current VMI supplied to the VM coil 79, the output voltage of the VM drive circuit 78 (hereinafter referred to as drive voltage), V_{L}, is expressed by the following equation (1):
V_{L}=2πfLI (1)
where the drive voltage V_{L} to be applied to the VM coil 79 by the VM drive circuit 78 is dependent upon the frequency f of the velocity modulation current VMI supplied to the VM coil 79. That is, in order to increase the frequency f of the velocity modulation current VMI, it is necessary to increase the drive voltage V_{L}. Nevertheless, the drive voltage V_{L} is limited by the withstand voltage of a transistor contained in the VM drive circuit 78. Consequently, when the frequency of the velocity modulation signal is high, the voltage to be applied to the VM coil 79 by the VM drive circuit 78 exceeds the upper limit of the drive voltage V_{L}.

Moreover, the VM coil 79 has capacitance components consisting of stray capacitance and line capacitance as well as inductance components. Therefore, the VM coil 79 has a low pass filter characteristic because of the inductance components and capacitance components. In this case, the greater the inductance components of the VM coil 79, the lower the cut-off frequency in the low pass filter characteristic.

As a result of this, when the frequency of the velocity modulation signal exceeds a certain value, the VM drive circuit 78 cannot follow the frequency of the velocity modulation signal. That is, the velocity modulation current VMI cannot follow the frequency of the velocity modulation signal.

It is assumed, for example, that the inductance of the VM coil 79 is 5 μH, and the voltage supplied to the VM coil 79 is 1 Ap-p. In this case, when the frequencies of the velocity modulation signal are 1 MHz, 10 MHz, and 100 MHz, voltages to be applied to the VM coil 79 by the VM drive circuit 78 are 31.4 Vp-p, 314 Vp-p, and 3140 Vp-p, respectively, based on the equation (1) above. In this manner, the voltage to be applied to the VM coil 79 by the VM drive circuit 78 increases with an increase in the frequency of the velocity modulation signal.

Assuming the upper limit of the drive voltage V_{L} of the VM drive circuit 78 to be about 140 Vp-p, the voltage to be applied to the VM coil 79 greatly exceeds the upper limit of the drive voltage V_{L} of the VM drive circuit 78 when the frequencies of the velocity modulation signal are 10 MHz and 100 MHz. Consequently, the VM drive circuit 78 cannot follow the frequency of the velocity modulation signal. As a result, it is not possible to precisely display the contour of an image including a high frequency component.

### DISCLOSURE OF INVENTION

An object of the present invention is to provide a video display apparatus in which contour correction for an image including a high-frequency component can be made.

A video display apparatus according to one aspect of the present invention comprises an electron beam scanning apparatus that scans on a screen an electron beam according to an input luminance signal, thereby producing a luminance distribution on the screen for the display of an image; a plurality of velocity modulation coils provided in the electron beam scanning apparatus, each generating a modulation magnetic field for modulating the scanning speed of the electron beam; and a plurality of scanning-speed modulation circuits that supply the plurality of velocity modulation coils with currents for modulating the scanning speed, respectively, based on the input luminance signal.

In the video display apparatus according to the present invention, the electron beam according to the input luminance signal is scanned on the screen by the electron beam scanning apparatus, and the luminance distribution is produced on the screen for the display of an image. In addition, the plurality of velocity modulation coils are supplied with the currents for modulating the scanning speed by the plurality of scanning-speed modulation circuits, respectively. This allows generation of the modulation magnetic field from each of the plurality of velocity modulation coils so as to modulate the scanning speed of the electron beam.

In this case, the provision of the plurality of velocity modulation coils makes it possible to decrease the inductance of each of the velocity modulation coils, so that the voltage to be applied to each of the velocity modulation coils can be decreased while the cut-off frequency of each of the velocity modulation coils can be increased. Consequently, each of the scanning-speed modulation circuits can follow a high frequency.

It is, therefore, possible to modulate the scanning speed of an electron beam in a high-frequency region without lowering the capability of speed modulation function, even when the luminance signal includes a high-frequency component, so that contour correction for an image including a high-frequency component can be made. As a result, an image including a high-frequency component can be precisely displayed.

The plurality of velocity modulation coils may have the same number of turns. In this case, each of the plurality of velocity modulation coils with the same number of turns is supplied with the current for modulating the scanning speed. This makes it possible to decrease the inductance of each of the velocity modulation coils.

Each of the plurality of scanning-speed modulation circuits may include a differentiation circuit that differentiates the luminance signal. In this case, the luminance signal input to each of the plurality of scanning-speed modulation circuits is differentiated by the differentiation circuit, and the current based on the differential waveform is supplied to each of the plurality of velocity modulation coils. Consequently, the contour of an image is emphasized.

The plurality of velocity modulation coils may have different numbers of turns. In this case, the plurality of velocity modulation coils with different numbers of turns are supplied with the respective currents for modulating the scanning speed. This makes it possible to provide velocity modulation based on the luminance signal having various frequency regions while decreasing the inductance of each of the velocity modulation coils. As a result, fine contour correction according to the frequency of the luminance signal can be made, and an image having various frequency components can be precisely displayed.

The plurality of scanning-speed modulation circuits may each include a differentiation circuit that differentiates the luminance signal; the differentiation circuits in the plurality of scanning-speed modulation circuits may have different differential frequencies; and the plurality of scanning-speed modulation circuits may be connected to the plurality of velocity modulation coils, respectively, such that a differentiation circuit having a lower differential frequency is combined with a velocity modulation coil having a greater number of turns.

In this case, the luminance signal input to each of the plurality of scanning-speed modulation circuits is differentiated, according to its frequency, by any of the plurality of differentiation circuits, and the current based on the differential waveform is supplied to the corresponding velocity modulation coil. Consequently, the contour of an image is emphasized.

In particular, when the luminance signal has low frequencies, the scanning-speed modulation coil can follow the frequencies of the luminance signal even with a large number of turns in the velocity modulation coil, i.e., a large inductance. On the contrary, when the luminance signals has high frequencies, the scanning-speed modulation circuit can follow the frequencies of the luminance signal by decreasing the number of turns in the velocity modulation coil, i.e., a smaller inductance. Consequently, the combination of a differential circuit having a lower differential frequency and a velocity modulation coil having a greater number of turns makes it possible to provide velocity modulation based on the luminance signal of a wide frequency region. As a result, fine contour correction according to the frequency of the luminance signal can be made, and an image having various frequency components can be precisely displayed.

Each of the plurality of scanning-speed modulation circuits may further include a low pass filter in a stage prior to the differentiation circuit; the low pass filters in the plurality of scanning-speed modulation circuits may have different cut-off frequencies; and the cut-off frequency of the low pass filter in each of the plurality of scanning-speed modulation circuits may be set such that a low pass filter having a lower cut-off frequency is combined with a differentiation circuit having a lower differential frequency.

In this case, in the stage prior to the differentiation circuit, predetermined frequency regions of the luminance signals input to the respective plurality of scanning-speed modulation circuits are cut by the low pass filters having different cut-off frequencies.

In particular, the luminance signal which has passed the low pass filter having a lower cut-off frequency is applied to the differentiation circuit having a lower differential frequency. This emphasizes the low-frequency component of the luminance signal. On the contrary, the luminance signal which has passed the low pass filter having a higher cut-off frequency is applied to the differentiation circuit having a higher differential frequency. This emphasizes the high-frequency component of the luminance signal.

Consequently, even when the luminance signal has various frequency components, contour correction can be made with the frequency components thereof being emphasized. As a result, fine contour correction according to the frequency of the luminance signal can be made, and an image having various frequency components can be precisely displayed.

The plurality of scanning-speed modulation circuits may include differentiation circuits that perform differentiation of different orders with respect to the respective luminance signals, and the plurality of scanning-speed modulation circuits may be connected to the plurality of velocity modulating circuits, respectively, such that a differentiation circuit that performs lower-order differentiation is combined with a velocity modulation coil having a greater number of turns.

In this case, the luminance signals input to the plurality of scanning-speed modulation circuits are subject to differentiation of different orders, respectively, by the differentiation circuits that perform differentiation of different orders with respect to the respective luminance signals.

In particular, the differential waveform obtained by the differentiation circuit that performs lower-order differentiation has low frequencies. In this case, the scanning-speed modulation circuit connected to the velocity modulation coil having a greater number of turns can follow the frequencies of the luminance signal.

On the other hand, the waveform obtained by the differentiation circuit that performs higher-order differentiation has high frequencies. In this case, the scanning-speed modulation circuit connected to the velocity modulation coil having a smaller number of turns can follow the frequencies of the luminance signal.

As described above, the combination of the differentiation circuit that performs lower-order differentiation and the velocity modulation coil having a greater number of turns makes it possible to emphasize the contour of an image, for the luminance signal of a wide frequency region. As a result, strong contour correction according to the frequency of the luminance signal can be made, and an image having various frequency components can be precisely displayed.

The electron beam scanning apparatus may include a cathode ray tube; a horizontal deflection device that deflects an electron beam in the cathode ray tube in the horizontal direction; and a vertical deflection device that deflects an electron beam in the cathode ray tube in the vertical direction, and the plurality of velocity modulation coils may be arranged so as to modulate the scanning speed of the electron beam in the horizontal direction.

In this case, in the cathode ray tube, the electron beam is deflected in the horizontal direction by the horizontal deflection device, and deflected in the vertical direction by the vertical deflection device. This allows an image displayed on the screen of the cathode ray tube. In addition, the scanning speed of the electron beam in the horizontal direction is modulated by the plurality of velocity modulation coils. Consequently, contour correction for an image is made, and a precise image having an emphasized contour is displayed.

A video display apparatus according to another aspect of the present invention comprises an electron beam scanning apparatus that scans on a screen an electron beam according to an input luminance signal, thereby producing a luminance distribution on the screen for the display of an image; first and second saddle-type velocity modulation coils provided opposed to each other in the electron beam scanning apparatus, each producing a modulation magnetic field for modulating the scanning speed of the electron beam; and a scanning-speed modulation circuit that supplies the first and second velocity modulation coils with currents for modulating the scanning speed, respectively, based on the input luminance signal.

In the video display apparatus according to the present invention, the electron beam according to the input luminance signal is scanned on the screen by the electron beam scanning apparatus, and the luminance distribution is produced on the screen for the display of an image. In addition, the first and second saddle-type velocity modulation coils provided opposed to each other in the electron beam scanning apparatus are supplied by the scanning-speed modulation circuit with the currents for modulating the scanning speed based on the luminance signal. This allows generation of the modulation magnetic field from each of the plurality of velocity modulation coils so as to modulate the electron beam.

In this case, the provision of the first and second velocity modulation coils makes it possible to decrease the inductance of each of the velocity modulation coils, thus allowing a decrease in the voltage to be applied to each of the modulation coils and an increase in the cut-off frequency of each of the velocity modulation coils. Consequently, the scanning-speed modulation circuit can follow high frequencies. Therefore, the scanning speed of the electron beam can be modulated, even when the luminance signal includes a high-frequency component. As a result, contour correction for an image including a high-frequency component can be made, and an image having a high-frequency component can be precisely displayed.

The scanning-speed modulation circuit may include a signal generation circuit that generates a scanning-speed modulation signal based on the input luminance signal; and first and second current supply circuits that supply currents for modulating the scanning speed to the first and second velocity modulation coils, respectively, based on the scanning-speed modulation signal generated by the signal generation circuit.

In this case, the scanning-speed modulation signal is generated based on the luminance signal input by the signal generation circuit, and the first and second velocity modulation coils are supplied with the currents for modulating the scanning speed based on the scanning-speed modulation signal by the first and second current supply circuits, respectively.

This decreases the voltages to be applied to the first and second velocity modulation coils by the first and second current supply circuits, respectively. Consequently, the first and second current supply circuits can follow high frequencies. This makes it possible to modulate the scanning speed of the electron beam even when the luminance signal includes a high-frequency component. As a result, contour correction for an image including a high frequency component can be made, and an image having a high-frequency component can be precisely displayed.

The first and second velocity modulation coils may be connected in parallel with each other; and the scanning-speed modulation circuit may include a signal generation circuit that generates a scanning-speed modulation signal based on the input luminance signal and a current supply circuit that supplies the first and second velocity modulation coils with a current for modulating the scanning speed based on the scanning-speed modulation signal generated by the signal generation circuit.

In this case, in the scanning-speed modulation circuit, the scanning-speed modulation signal is generated based on the luminance signal input by the signal generation circuit, and the currents based on the scanning-speed modulation signal are supplied to the first and second velocity modulation coils connected in parallel with each other. The supply of currents based on the scanning-speed modulation signal to the first and second velocity modulation coils results in the modulation of the scanning speed.

In particular, the provision of the first and second velocity modulation coils in parallel decreases a synthesized inductance of the first and second velocity modulation coils, thereby decreasing the voltages to be applied to the first and second velocity modulation coils while increasing the cut-off frequencies of the first and second velocity modulation coils. Consequently, the scanning-speed modulation circuit can follow high frequencies. As a result, contour correction for an image including a high-frequency component can be made, and an image having a high-frequency component can be precisely displayed.

The electron beam scanning apparatus may include a cathode ray tube; a horizontal deflection device that deflects an electron beam in the cathode ray tube in the horizontal direction; and a vertical deflection device that deflects an electron beam in the cathode ray tube in the vertical direction, and the first and second velocity modulation coils may be arranged so as to modulate the scanning speed of the electron beam in the horizontal direction.

In this case, in the cathode ray tube, the electron beam is deflected in the horizontal direction and deflected in the vertical direction by the horizontal deflection device. This allows an image displayed on the screen of the cathode ray tube. In addition, the scanning speed of the electron beam in the horizontal direction is modulated by the first and second velocity modulation coils. This provides contour correction for an image. Consequently, an image with an emphasized contour is attained.

### BRIEF DESCRIPTION OF DRAWINGS

FIG. 1 is a block diagram showing the configuration of a video display apparatus according to a first embodiment;

FIG. 2 is a waveform diagram for explaining the operation of the video display apparatus shown in FIG. 1;

FIG. 3 is a block diagram showing the configuration of a video display apparatus according to a second embodiment;

FIG. 4 is a block diagram showing the configuration of a video display apparatus according to a third embodiment;

FIG. 5 is a block diagram showing the configuration of a video display apparatus according to a fourth embodiment;

FIG. 6 is a block diagram showing the configuration of a video display apparatus according to a fifth embodiment;

FIG. 7 is a block diagram showing one example of the video display apparatus according to the fifth embodiment provided with two scanning-speed modulation circuit blocks;

FIG. 8 is a schematic diagram showing the waveforms of a luminance signal applied to the scanning-speed modulation circuit blocks shown in FIG. 7; of velocity modulation currents supplied to respective VM coils by the scanning-speed modulation circuit blocks; and of velocity modulation magnetic fields produced by the plurality of VM coils;

FIG. 9 is a block diagram showing the configuration of a video display apparatus according to a sixth embodiment;

FIG. 10 is a block diagram showing the configuration of a video display apparatus according to a seventh embodiment;

FIG. 11 is a schematic diagram showing the shape and configuration of the velocity modulation coil shown in FIG. 10;

FIG. 12 is a block diagram showing the configuration of a velocity modulation signal generation circuit;

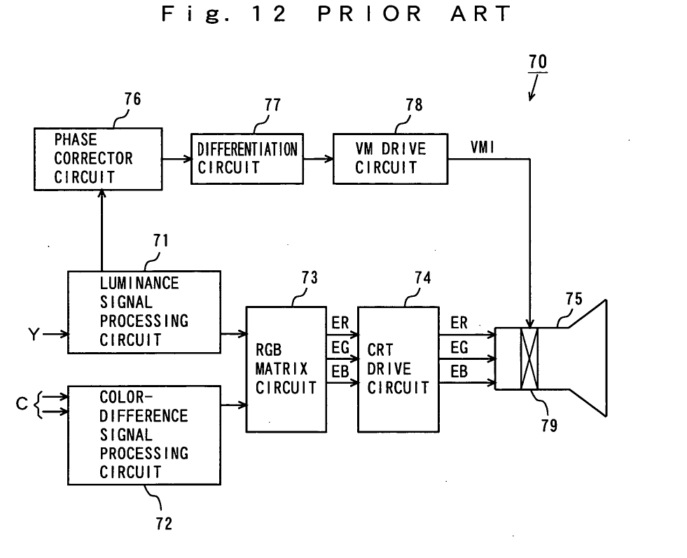

FIG. 13 is a schematic diagram showing the shape and configuration of the velocity modulation coil shown in FIG. 12;

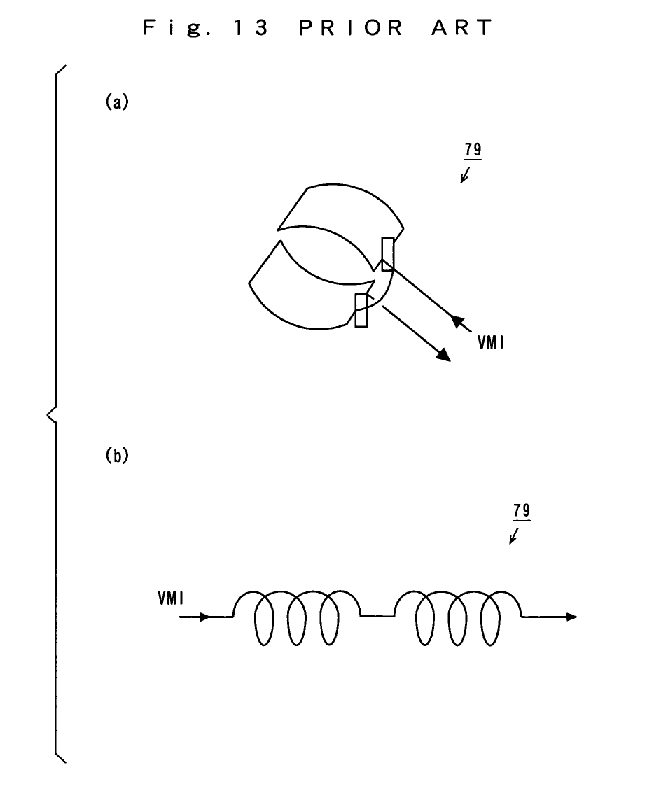

FIG. 14 is a waveform diagram for explaining the operation of the velocity modulation signal generation circuit shown in FIG. 12.

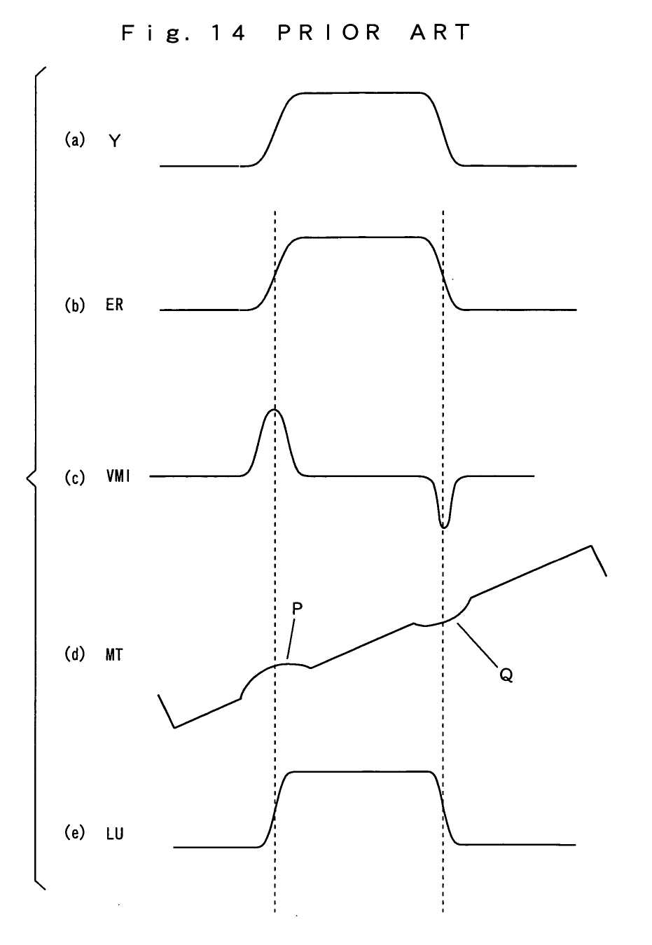

### BEST MODE FOR CARRYING OUT THE INVENTION

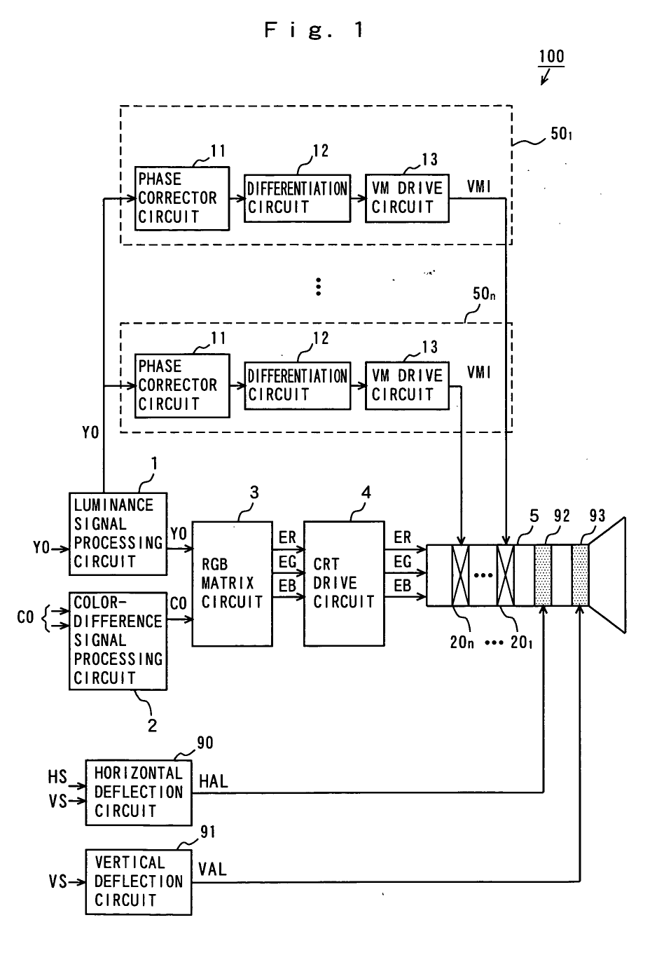

Description will hereinafter be made of embodiments of the present invention with reference to FIG. 1 to FIG. 11.

### First Embodiment

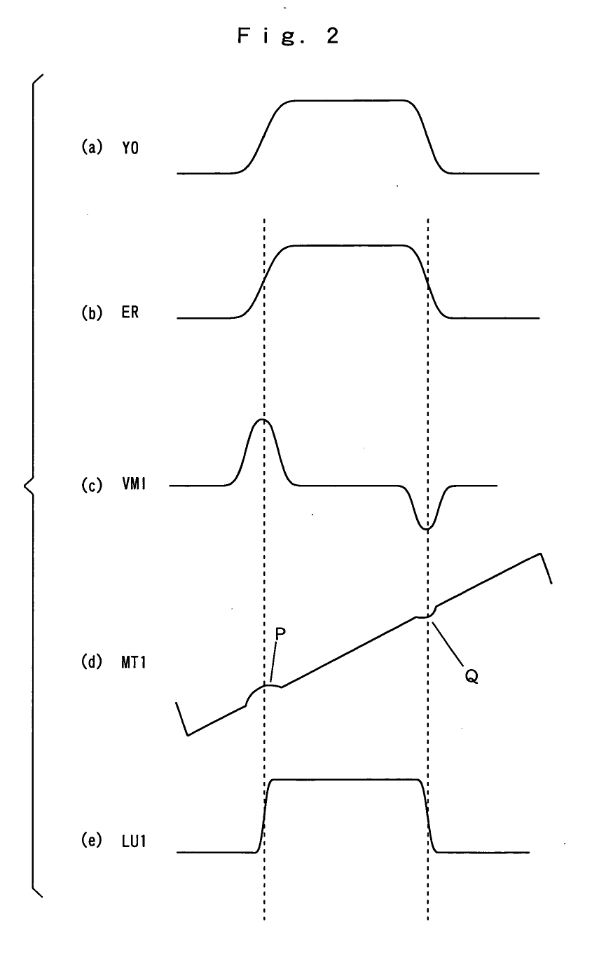

FIG. 1 is a block diagram showing the configuration of a video display apparatus according to a first embodiment, and FIG. 2 is a waveform diagram for use in illustrating the operation of the video display apparatus shown in FIG. 1.

The video display apparatus 100 according to the first embodiment comprises a luminance signal processing circuit 1, a color-difference signal processing circuit 2, an RGB matrix circuit 3, a cathode ray tube (hereinafter refereed to as CRT) drive circuit 4, a CRT 5, a plurality of velocity modulation (hereinafter abbreviated to VM) coils 20₁ to 20ₙ (n is an integer not less than two), a plurality of scanning-speed modulation circuit blocks 50₁ to 50ₙ (n is an integer not less than two), a horizontal deflection circuit 90, a vertical deflection circuit 91, a horizontal deflection coil 92, and a vertical deflection coil 93.

The scanning-speed modulation circuit blocks 50₁ to 50ₙ each comprise a phase corrector circuit 11, a differentiation circuit 12, and a VM drive circuit 13, and they are individually connected to the respective VM coils 20₁ to 20ₙ. The VM coils 20₁ to 20ₙ, the horizontal deflection coil 92, and the vertical deflection coil 93 are mounted in the CRT 5.

In the present embodiment, each of the plurality of scanning-speed modulation circuit blocks 50₁ to 50ₙ has the same configuration and performance, and each of the plurality of VM coils 20₁ to 20ₙ has the same number of turns.

The luminance signal processing circuit 1 and the color-difference signal processing circuit 2 each have a delay circuit (not shown).

In the video display apparatus 100 shown in FIG. 1, a luminance signal Y0 is input to the luminance signal processing circuit 1, while a color difference signal C0 is input to the color-difference signal processing circuit 2. In addition, a horizontal synchronizing signal HS and a vertical synchronizing signal VS are input to the horizontal deflection circuit 90 and a vertical synchronizing signal VS is input to the vertical deflection circuit 91.

The luminance signal Y0 input to the luminance signal processing circuit 1 is delayed for a predetermined period of time while being processed for correction of an image, and the processed luminance signal Y0 is applied to the RGB matrix circuit 3. FIG. 2(a) shows one example of the waveform of the processed luminance signal Y0.

The color difference signal C0 input to the color-difference signal processing circuit 2 is delayed for a predetermined period of time while being processed for correction of an image, and applied to the RGB matrix circuit 3.

In the RGB matrix circuit 3, primary color signals ER, EG, EB, corresponding to the respective luminances of red, green, and blue are generated based on the luminance signal Y0 and color difference signal C0. The generated primary signals ER, EG, EB are applied to the CRT drive circuit 4.

In the CRT drive circuit 4, the primary color signals ER, EG, EB applied from the matrix circuit 3 are amplified. FIG. 2(b) shows one example of the waveform of the primary color signal ER. In the CRT 5, an electron beam based on the primary color signals, ER, EG, EB is emitted.

The horizontal deflection circuit 90 produces a horizontal deflection current HAL based on the input horizontal synchronizing signal HS and vertical synchronizing signal VS, supplying the produced current to the horizontal deflection coil 92. This results in the generation of a horizontal deflection magnetic field from the horizontal deflection coil. As a result, the above-mentioned electron beam is horizontally scanned on a screen.

The vertical deflection circuit 91 produces a vertical deflection current VAL based on the input vertical synchronizing signal VS, supplying the produced current to the vertical deflection coil 93. This results in the generation of a vertical deflection magnetic field from the vertical deflection coil 93. As a result, the above-mentioned electron beam is vertically scanned on the screen. Consequently, an image is displayed on the screen of the CRT 5.

Further, the luminance signal Y0 processed by the luminance signal processing circuit 1 (FIG. 2(a)) is applied to the phase corrector circuit 11 in each of the scanning-speed modulation circuit blocks 50₁ to 50ₙ. In the phase corrector circuit 11, the phase of the luminance signal Y0 is corrected. The corrected luminance signal Y0 is applied to the differentiation circuit 12.

In the differentiation circuit 12, the luminance signal Y0 is first-order differentiated to generate a velocity modulation signal. The generated velocity modulation signal is applied to the VM drive circuit 13.

In the VM drive circuit 13, a velocity modulation current VMI is output based on the velocity modulation signal generated by the differentiation circuit 12. FIG. 2(c) shows one example of the waveform of the velocity modulation current VMI.

Note that as shown in FIG. 2(b), (c), the delay time of the luminance signal Y0 in the luminance signal processing circuit 1 and the delay time of the color difference signal C0 in the color-difference signal processing circuit 2 are set such that a rising edge and a falling edge of the primary color signal ER correspond to a peak position and a bottom position of the velocity modulation current VMI, respectively.

The velocity modulation currents VMI output from the VM drive circuits 13 in the scanning-speed modulation circuit blocks 50₁ to 50ₙ are applied to the VM coils 20₁ to 20ₙ, respectively. This results in the generation of a velocity modulation magnetic from each of the VM coils 20₁ to 20ₙ.

FIG. 2(d) shows a magnetic field MT 1 obtained by synthesizing the horizontal deflection magnetic field generated by the horizontal deflection coil 92 and the velocity modulation magnetic field generated by each of the VM coils 20₁ to 20ₙ based on the velocity modulation magnetic field VMI shown in FIG. 2(c).

As can be seen from FIG. 2(d), the horizontal deflection magnetic field generated by the horizontal deflection coil 92 changes partially at points P and Q, corresponding to the velocity modulation current VMI shown in FIG. 2(c). This allows the horizontal scanning speed of an electron beam to be partially modulated.

As a result, the luminance distribution on the screen of CRT 5 abruptly changes according to the changes of the luminance signal Y0, so that contour correction for an image is made. FIG. 2(e) shows a luminance distribution LU 1 on the screen of the CRT 5 in this case.

In the present embodiment, the provision of the plurality of scanning-speed modulation circuit blocks 50₁ to 50ₙ and the plurality of VM coils 20₁ to 20ₙ allows precise display of a contour with abrupt rising and falling of the luminance signal Y0, as will be described later.

Here, the degree of velocity modulation for an electron beam made by the VM coil is expressed by ampere-turn (current flowing in the VM coil x number of turns in the VM coil).

Where n VM coils, 20₁ to 20ₙ, are used to realize a predetermined ampere-turn, the number of turns in each of the VM coils 20₁ to 20ₙ can be decreased to 1/n the case using one VM coil. Consequently, the inductance in each of the VM coils 20₁ to 20ₙ can be decreased to n/1.

For example, a case realizing four ampere-turns will be examined. Where one VM coil is used, a current of 1 Ap-p is supplied with the number of turns in the VM coil set at four. Where four VM coils are used, on the other hand, a current of 1 Ap-p is supplied with the number of turns in each of the VM coils set at one. Consequently, four ampere-turns can be realized.

Using four VM coils as in the above, the number of turns in each of the VM coils can be decreased to ¼ the case using one VM coil. That is, the inductance in each of the VM coils can be decreased to ¼.

In the video display apparatus 100 according to the present embodiment, the provision of the plurality of scanning-speed modulation circuit blocks 50₁ to 50ₙ and the plurality of VM coils 20₁ to 20ₙ makes it possible to reduce the inductance in each of the VM coils 20₁ to 20ₙ to 1/n, as described above.

In this case, the voltage to be applied to each of the VM coils 20₁ to 20ₙ is reduced, while the cut-off frequency of each of the VM coils 20₁ to 20ₙ is increased. This allows each of the VM drive circuits 13 to follow the frequencies of the velocity modulation signal even when the velocity modulation signal has high frequencies. In other words, the velocity modulation current VMI supplied to each of the VM coils 20₁ to 20ₙ can follow the velocity modulation signal. It is therefore possible to modulate the horizontal scanning speed of an electron beam in a high-frequency region without lowering the capability of velocity modulation function, thereby providing contour correction for an image including a high-frequency component. As a result, an image having a high-frequency component can be precisely displayed.

### Second Embodiment

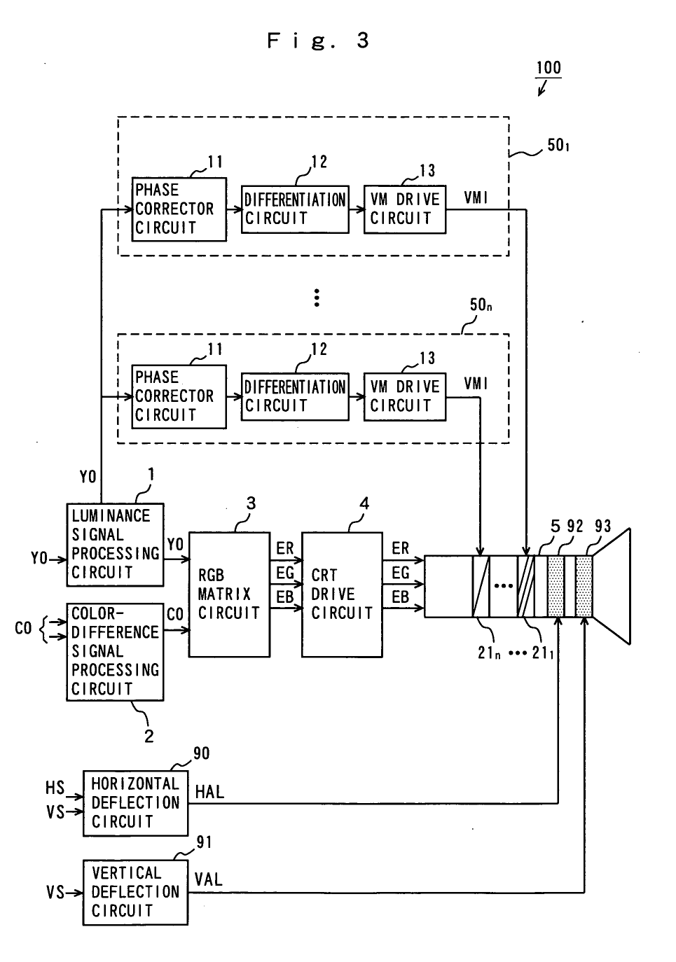

FIG. 3 is a block diagram showing the configuration of a video display apparatus according to a second embodiment.

The video display apparatus 100 according to the second embodiment has the same configuration as that of the video display apparatus 100 according to the first embodiment except that it comprises a plurality of VM coils 21₁ to 21ₙ (n is an integer not less than two) in place of the plurality of VM coils 20₁ to 20ₙ according to the first embodiment.

The VM coils 21₁ to 21ₙ have different numbers of turns from one another, and the VM coil 21ₙ has a smaller number of turns than that of the VM coil 21ₙ. In FIG. 3, the number of slashes represents the number of turns in each of the VM coils 21₁ to 21ₙ. In FIG. 3, the VM coil 21₁ has three turns, whereas the VM coil 21ₙ has one turn.

The inductance in each of the VM coils 21₁ to 21ₙ is proportional to the number of turns in each of the VM coils 21₁ to 21ₙ. That is, the greater the number of turns in a VM coil, the greater the inductance of the VM coil. Conversely, the smaller the number of turns in a VM coil, the smaller the inductance of the VM coil.

In the video display apparatus 100 according to the present embodiment, for the velocity modulation signal having low frequencies, suitable velocity modulation is made by the VM coil with a greater number of turns, whereas for the velocity modulation signal having high frequencies, suitable velocity modulation is made by the VM coil with a smaller number of turns. Consequently, the horizontal scanning speed of an electron beam can be modulated in various frequency regions, and fine contour correction according to the frequencies of the luminance signal can be made. As a result, an image having various frequency components can be precisely displayed.

Note that not all of the VM coils 21₁ to 21ₙ may necessarily have different numbers of turns, and some of the VM coils 21₁ to 21ₙ may have the same number of turns.

### Third Embodiment

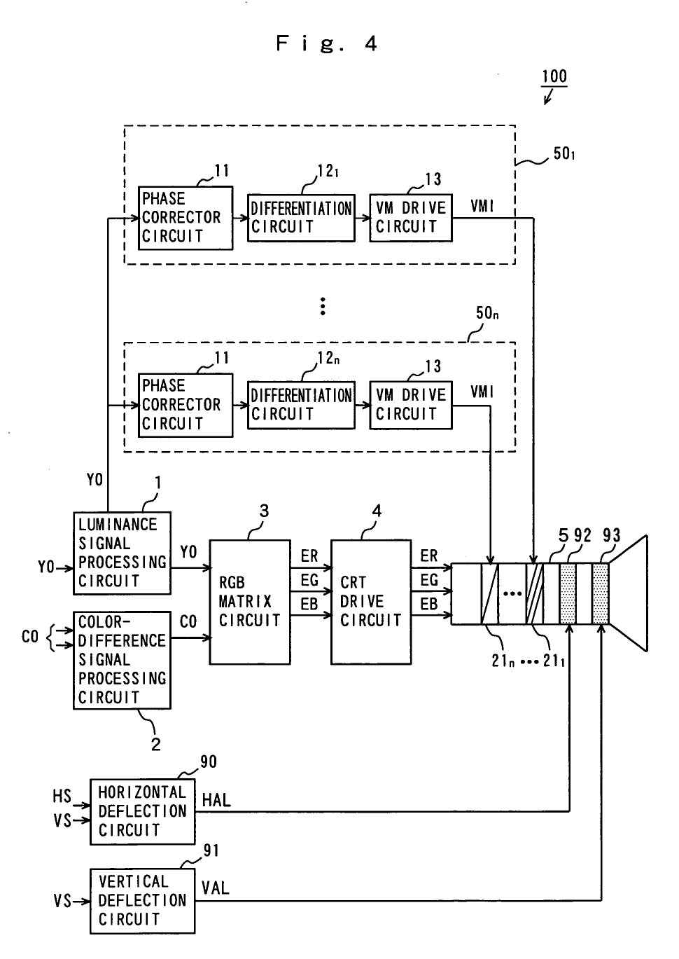

FIG. 4 is a block diagram showing the configuration of a video display apparatus according to a third embodiment.

The video display apparatus 100 according to the third embodiment has the same configuration as that of the video display apparatus 100 according to the second embodiment except that it comprises a plurality of differentiation circuits 12₁ to 12ₙ (n is an integer not less than 2) in place of the plurality of differentiation circuits 12 according to the second embodiment.

The differentiation circuits 12₁ to 12ₙ have different differential frequencies. The differential frequency of the differentiation circuit 12ₙ is higher than that of the differentiation circuit 12ₙ₋₁.

In other words, with n being two, the differentiation circuit 12₁ is set to perform first-order differentiation with respect to the luminance signal Y0 having lower frequencies, and the differentiation circuit 12₂ is set to perform first-order differentiation with respect to the luminance signal Y0 having higher frequencies.

The scanning-speed modulation circuit blocks 50₁ to 50ₙ comprising the differentiation circuits 12₁ to 12ₙ are connected to VM coils 21₁ to 21ₙ, respectively, which are the same as those of the second embodiment. In this case, the scanning-speed modulation circuit block comprising the differentiation circuit having lower frequencies is connected to the VM coil having a greater number of turns, whereas the scanning-speed modulation circuit block comprising the differentiation circuit having higher frequencies is connected to the VM coil having a smaller number of turns.

For example, with n being two, the scanning-speed modulation circuit block 50₁ comprising the differentiation circuit 12₁ having lower frequencies is connected to the VM coil 21₁ having a greater number of turns.

On the other hand, the scanning-speed modulation circuit block 50₂ comprising the differentiation circuit 12₂ having higher frequencies is connected to the VM coil 21₂ having a smaller number of turns.

As described above, the combination of the differentiation circuit having lower frequencies and a VM coil having a greater number of turns makes it possible to modulate the scanning speed of an electron beam in a low-frequency region, whereas the combination of a differentiation circuit having higher frequencies and a VM coil having a smaller number of turns makes it possible to modulate the scanning speed of an electron beam in a high-frequency region. Consequently, the horizontal scanning speed of an electron beam can be modulated in various frequency regions, and fine contour correction according to the frequencies of the luminance signal can be made. As a result, an image having various frequency components can be precisely displayed.

Note that not all of the differentiation circuits 12₁ to 12ₙ may necessarily have different differential frequencies, and some of the differentiation circuits 12₁ to 12ₙ may have the same differential frequency.

### Fourth Embodiment

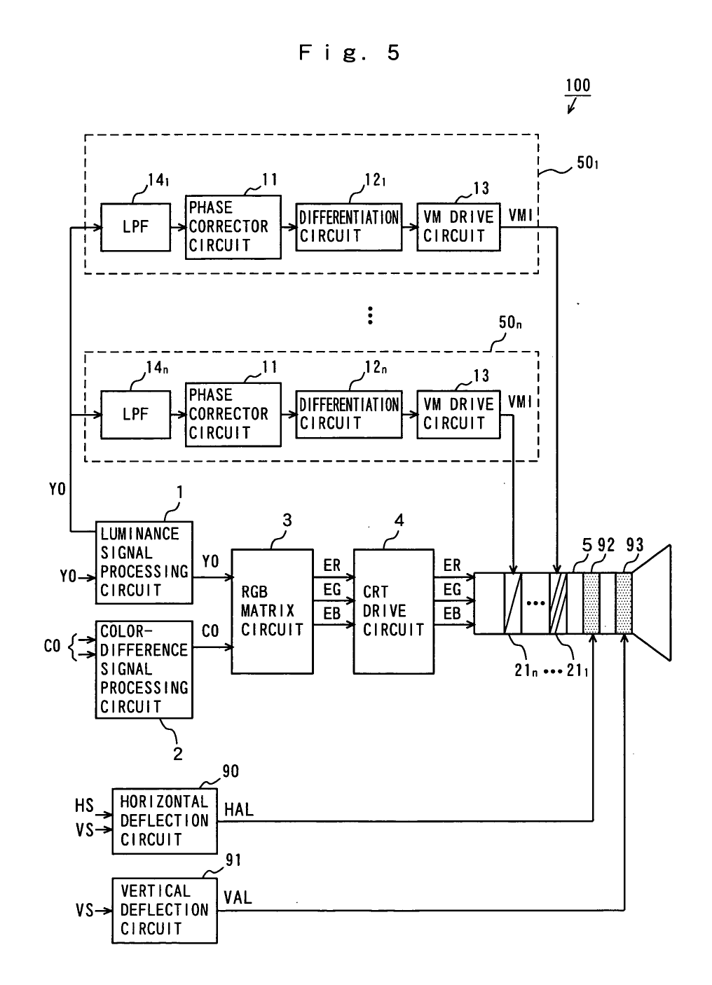

FIG. 5 is a block diagram showing the configuration of a video display apparatus according to a fourth embodiment.

The video display apparatus 100 according to the fourth embodiment has the same configuration as that of the video display apparatus 100 according to the third embodiment except that the plurality of scanning-speed modulation circuit blocks 50₁ to 50ₙ according to the third embodiment further comprise low pass filters (hereinafter abbreviated to LPF) 14₁ to 14ₙ (n is an integer not less than two), respectively.

In the scanning-speed modulation circuit blocks 50₁ to 50ₙ, the LPFs 14₁ to 14ₙ are provided in the respective stages prior to the phase corrector circuits 11. The cut-off frequencies of the LPFs 14₁ to 14ₙ are different from one other. The LPF having a higher cut-off frequency is connected to the stage prior to the differentiation circuit having a higher differential frequency. The LPF having a lower cut-off frequency is connected to the preceding stage of the differentiation circuit having a lower differential frequency. This allows first-order differentiation of the luminance signals Y0 having the frequencies according to preset frequency regions by the respective differentiation circuits 12₁ to 12ₙ.

With n being two, for example, the cut-off frequency of the LPF 14₁ is lower than the cut-off frequency of the LPF 14₂. Accordingly, the luminance signal Y0 having lower frequencies which passes the LPF 14₁ is applied to the differentiation circuit 12₁ having a lower differential frequency. This allows first-order differentiation of the luminance signal Y0 having lower frequencies in the differentiation circuit 12₁.

On the other hand, the luminance signal Y0 having higher frequencies which passes the LPF 14₂ is applied to the differentiation circuit 12₂ having a higher differential frequency. This allows first-order differentiation of the luminance signal Y0 having higher frequencies in the differentiation circuit 12₂.

The scanning-speed modulation circuit block 50₁ comprising the LPF 14₁ of a lower cut-off frequency and the differentiation circuit 12₁ of a lower differential frequency is connected to the VM coil 21₁ having a greater number of turns.

On the other hand, the scanning-speed modulation circuit block 50₂ comprising the LPG 14₂ of a higher cut-off frequency and the differentiation circuit 12₂ of a higher differential frequency is connected to the VM coil 21₁ having a smaller number of turns.

As described above, the LPF of a lower cut-off frequency and the differentiation circuit of a lower differential frequency are combined with the VM coil having a greater number of turns, so that the scanning speed can be modulated for an electron beam in a low-frequency region, whereas the LPF of a higher cut-off frequency and the differentiation circuit of a higher differential frequency are combined with the VM coil having a smaller number of turns, so that the scanning speed can be modulated for an electron beam in a high-frequency region. Consequently, the combination of the LPFs 14₁ to 14ₙ, the differentiation circuits 12₁ to 12ₙ, and the scanning-speed modulation circuit blocks 50₁ to 50ₙ allows the modulation of the horizontal scanning speed of an electron beam in significantly increased frequency regions, thereby providing fine contour correction according to the frequencies of the luminance signal. As a result, an image having a very large amount of frequency components can be precisely displayed.

Note that not all of the LPFs 14₁ to 14ₙ may necessarily have different cut-off frequencies, and some of the LPFs 14₁ to 14ₙ may have the same cut-off frequency.

### Fifth Embodiment

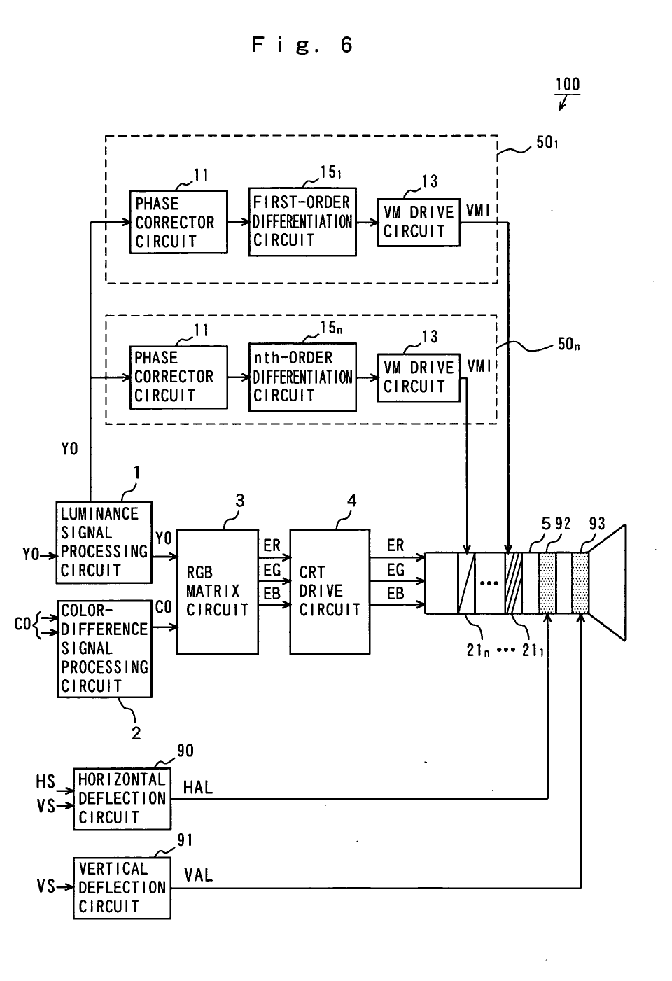

FIG. 6 is a block diagram showing the configuration of a video display apparatus according to a fifth embodiment.

The video display apparatus 100 according to the fifth embodiment has the same configuration as that of the video display apparatus 100 according to the third embodiment except that it comprises first-order differentiation circuit 15₁ to nth-order differentiation circuit 15ₙ in place of the plurality of differentiation circuits 12₁ to 12ₙ according to the third embodiment.

The first-order differentiation circuit 15₁ performs first-order differentiation with respect to an applied luminance signal Y0, and the nth-order differentiation circuit 15ₙ performs nth-order differentiation with respect to an applied luminance signal Y0. Note that n is an integer not less than two.

With n being two, for example, the first-order differentiation circuit 15₁ performs first-order differentiation with respect to the luminance signal Y0 applied from the phase corrector circuit 11, whereas the second-order differentiation circuit 15₂ performs second-order differentiation with respect to the luminance signal Y0 applied from the phase corrector circuit 11.

The scanning-speed modulation circuit blocks 50₁ to 50ₙ comprising the first-order differentiation circuit 15₁ to nth-order differentiation circuit 15ₙ are connected to the VM coils 21₁ to 21ₙ, respectively, which are the same as those of the second embodiment.

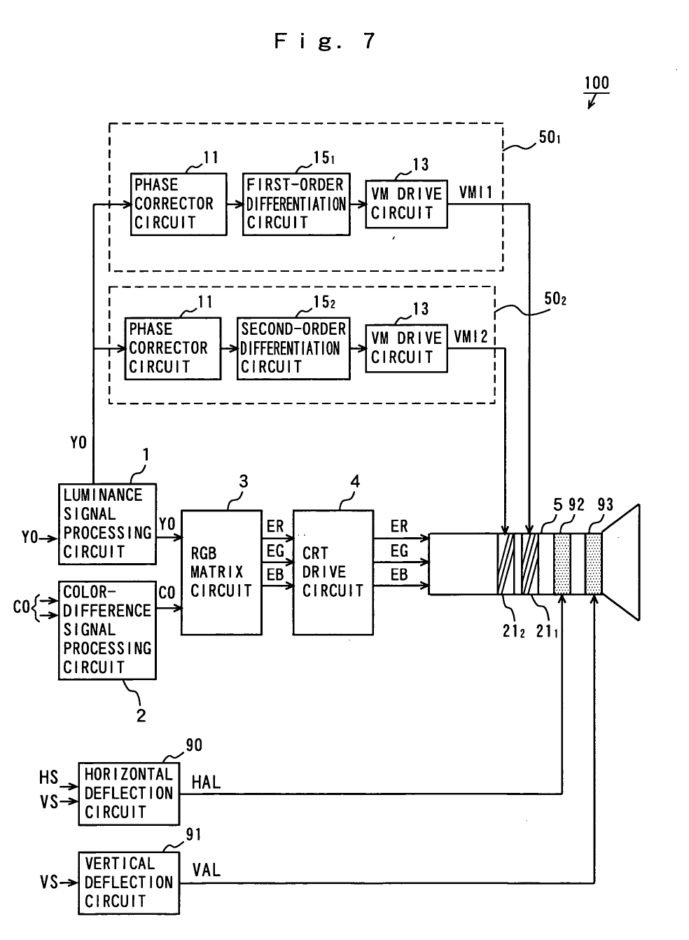

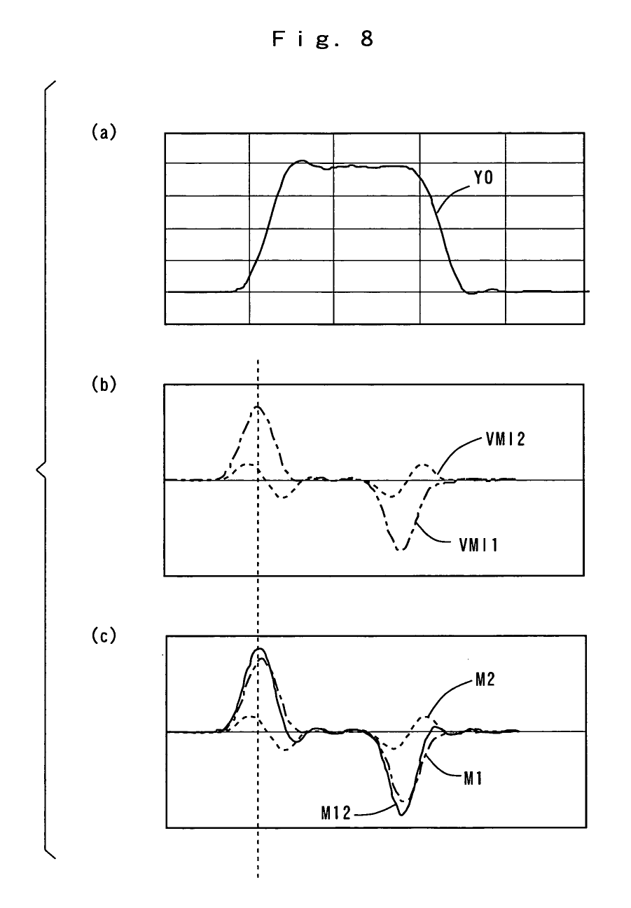

Referring to FIGS. 7 and 8, description will now be made of the configuration and operation of the video display apparatus 100 with n being two.

FIG. 7 is a block diagram showing one example of the video display apparatus according to the fifth embodiment provided with two scanning-speed modulation circuit blocks. FIG. 8 is a schematic diagram showing the waveform of a luminance signal applied to the scanning-speed modulation circuit blocks shown in FIG. 7, the waveforms of velocity modulation currents supplied to respective VM coils by the scanning-speed modulation circuit blocks, and the waveforms of velocity modulation magnetic fields produced by the plurality of VM coils.

Where n is two, the video display apparatus 100 comprises two scanning-speed modulation circuit blocks 50₁, 50₂.

In the scanning-speed modulation circuit blocks 50₁, 50₂, the luminance signal Y0 shown in FIG. 8(a) is input to the respective phase corrector circuits 11 by the luminance signal processing circuit 1.

In the scanning-speed modulation circuit block 50₁, the luminance signal Y0 applied to the first-order differentiation circuit 15₁ from the phase corrector circuit 11 is first-order differentiated by the first-order differentiation circuit 15₁ to generate a velocity modulation signal. The VM drive circuit 13 supplies a velocity modulation current VMI1 represented by the chain line in FIG. 8(b) to a VM coil 21₁ based on the generated velocity modulation signal. This causes the VM coil 21₁ to generate a velocity modulation magnetic field M1.

In the scanning-speed modulation circuit block 50₂, the luminance signal Y0 applied to the second-order differentiation circuit 15₂ from the phase corrector circuit 11 is second-order differentiated to generate a velocity modulation signal. The VM drive circuit 13 supplies a velocity modulation current VMI 2 represented by the broken line in FIG. 8(b) to a VM coil 21₂ based on the generated velocity modulation signal. This causes the VM coil 21₂ to generate a velocity modulation magnetic field M2.

FIG. 8(c) shows one example of the waveform of the velocity modulation magnetic field M1 from the VM coil 21₁ by the chain line, one example of the waveform of the velocity modulation magnetic field M2 from the VM coil 21₁ by the chain line, and one example of the waveform of the velocity modulation magnetic field M12 obtained by synthesizing the velocity modulation magnetic field M1 and the velocity modulation magnetic field M2 by the solid line.

As can be seen from FIG. 8(c), in the waveform of the velocity modulation magnetic field M12 obtained by synthesizing the velocity modulation magnetic field M1 and the velocity modulation magnetic field M2, the rising period and falling period are shorter than those of the velocity modulation magnetic field M1. In this case, rising and falling of the velocity modulation can be provided more abruptly, leading to stronger contour correction for an image.

By the way, when the luminance signal Y0 is n-th order differentiated in the video display apparatus 100 shown in FIG. 6, the frequencies of the resulting velocity modulation signal increase as n increases.

Therefore, in the present embodiment, the scanning-speed modulation circuit block having a higher-order differentiation circuit is connected to the VM coil having a smaller number of turns, whereas the scanning-speed modulation circuit block having a lower-order differentiation circuit is connected to the VM coil having a greater number of turns. This allows the VM drive circuit connected to the higher-order differentiation circuit to follow the velocity modulation signal having higher frequencies, and also allows the VM drive circuit connected to the lower-order differentiation circuit to follow the velocity modulation signal having lower frequencies.

As can be seen from FIG. 7, the scanning-speed modulation circuit block 50₁ comprising the first-order differentiation circuit 15₁ is connected to the VM coil 21₁ having a greater number of turns, whereas the scanning-speed modulation circuit block 50₂ comprising the second-order differentiation circuit 15₂ is connected to the VM coil 21₂ having a smaller number of turns. In this case, because of the smaller number of turns in the VM coil 21₂, the VM drive circuit 13 can follow the velocity modulation signal having high frequencies.

As described above, the combination of the lower-order differentiation circuit and the VM coil having a greater number of turns makes it possible to modulate the scanning speed of ah electron beam in a low-frequency region, whereas the combination of the higher-order differentiation circuit and the VM coil having a smaller number of turns makes it possible to modulate the scanning speed of an electron beam in a high-frequency region. Consequently, the horizontal scanning speed of an electron beam can be modulated in various frequency regions, leading to strong contour correction according to the frequencies of the luminance signal. As a result, an image having various frequency components can be precisely displayed.

Note that not all of the first-order differentiation circuit 15₁ to nth-order differentiation circuit 15ₙ may necessarily perform differentiation of different orders, and some of the first-order differentiation circuit 15₁ to nth-order differentiation circuit 15ₙ may perform differentiation of the same order.

### Sixth Embodiment

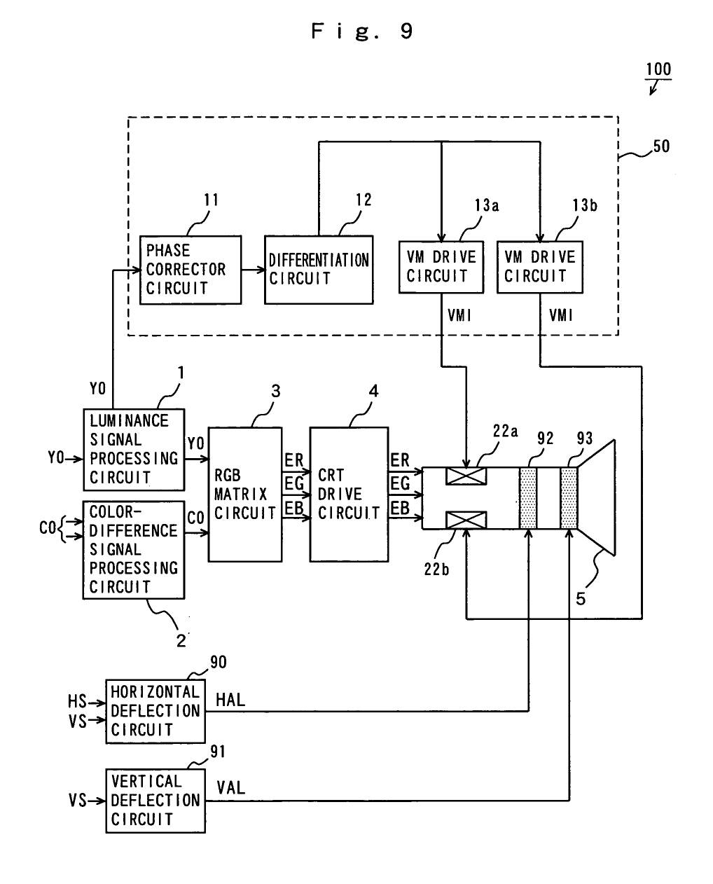

FIG. 9 is a block diagram showing the configuration of a video display apparatus according to a sixth embodiment.

The video display apparatus 100 according to the sixth embodiment has the same configuration as that of the video display apparatus according to the first embodiment except that it comprises a scanning-speed modulation circuit block 50 having two VM drive circuits 13a, 13b in place of the plurality of scanning-speed modulation circuit blocks 50₁ to 50ₙ according to the first embodiment, and a pair of VM coils 22a, 22b in place of the plurality of VM coils 20₁ to 20ₙ according to the first embodiment.

In the scanning-speed modulation circuit block 50 according to the present embodiment, a velocity modulation signal generated by the differentiation circuit 12 is applied to the two VM drive circuits 13a, 13b.

The VM coils 22a, 22b are each constituted by a saddle-type coil, one saddle-type coil and the other being provided at an upper part and a lower part of the CRT 5, respectively, to be opposed to each other. The VM coils 22a, 22b have the same number of turns.

The VM drive circuit 13a is connected to the VM coil 22a, supplying with the VM coil 22a a velocity modulation current VMI based on the velocity modulation signal. On the other hand, the VM drive circuit 13b is connected to the VM coil 22b, supplying with the VM coil 22b a velocity modulation current VMI based on the velocity modulation signal.

In this case, the velocity modulation currents produced by the respective VM coil 22a, 22b can be reduced to half the case using one VM coil conventionally. Therefore, each of the inductances of the VM coils 22a, 22b can be reduced to half with the velocity modulation current conventionally obtained by using one VM coil being assured.

In the video display apparatus 100 according to the present embodiment, the provision of the two VM drive circuits 13a, 13b, and the pair of VM coils 22a, 22b makes it possible to reduce each of the inductances of the VM coils 22a, 22b to half, as described above. This allows each of the VM drive circuits 13a, 13b to follow the frequencies of the velocity modulation signal even when the velocity modulation signal have high frequencies. In other words, the velocity modulation currents VMI supplied to the respective VM coils 22a, 22b can follow the velocity modulation signal. Consequently, it is possible to modulate the horizontal scanning speed of an electron beam in a high-frequency region, thereby providing contour correction for an image including a high-frequency component. As a result, an image having a high-frequency component can be precisely displayed.

### Seventh Embodiment

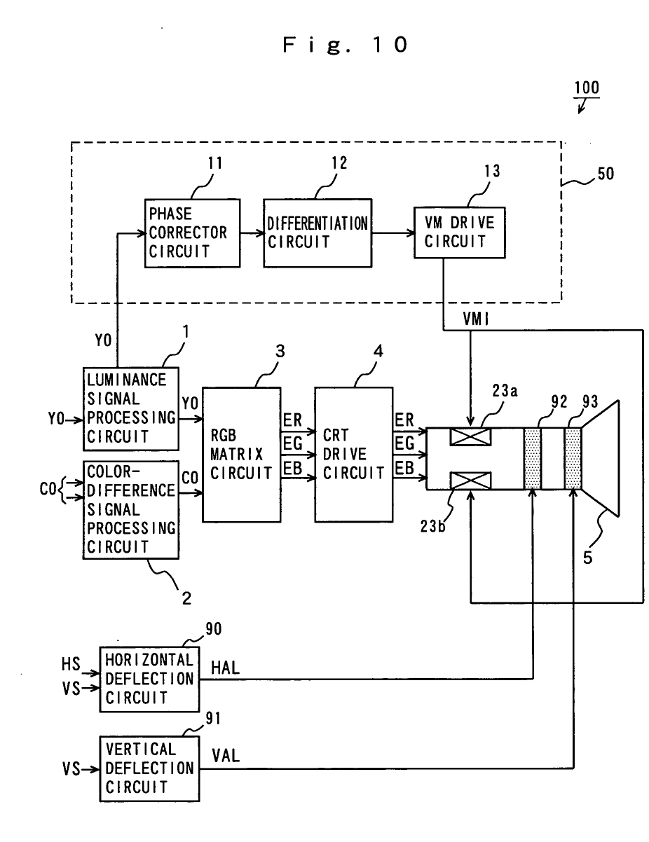

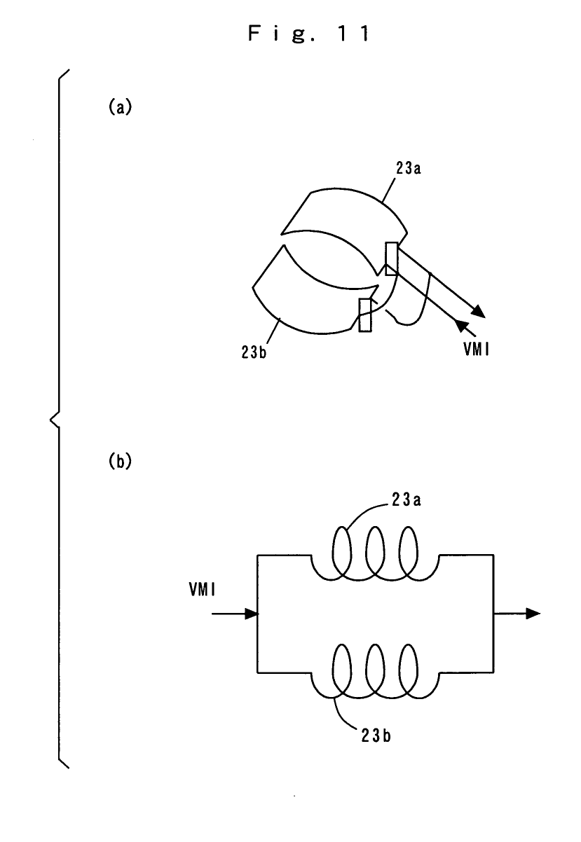

FIG. 10 is a block diagram showing the configuration of a video display apparatus according to a seventh embodiment, and FIG. 11 is a schematic diagram showing the shapes and configurations of the velocity modulation coils shown in FIG. 10.

The video display apparatus 100 according to the seventh embodiment has the same configuration as that of the video display apparatus 100 according to the first embodiment except that it comprises a scanning-speed modulation circuit block 50 in place of the plurality of scanning-speed modulation circuit blocks 50₁ to 50ₙ according to the first embodiment, and a pair of VM coils 23a, 23b, in place of the plurality of VM coils 20₁ to 20ₙ.

As shown in FIG. 11(a), the VM coil 22a and VM coil 23b are connected in parallel with each other. Accordingly, a synthesized inductance of the VM coils 23a, 23b is reduced to half the inductance of one VM coil.

The VM coils 23a, 23b can be represented by an equivalent circuit as shown in FIG. 11(b). Note that although each of the VM coils 23a, 23b is shown to have one turn in FIG. 11 (b), each of the VM coils 23a, 23b has, in fact, several turns. In addition, in the present embodiment, the upper VM coil 23a and lower VM coil 23b have the same number of turns. The VM drive circuit 13 is connected to the VM coils 23a, 23b connected in parallel.

When the VM coils 23a, 23b are supplied with a velocity modulation current VMI from the VM drive circuit 13 in the scanning-speed modulation circuit block 50, velocity modulation magnetic fields are generated from the VM coils 23a, 23b to modulate the speed of an electron beam.

In the video display apparatus 100 according to the present embodiment, the parallel connection of the upper VM coil 23a and the lower VM coil 23b makes it possible to reduce the synthesized inductance of the VM coils 23a, 23b to half the case conventionally obtained by using one VM coil, as described above. This allows the VM drive circuit 13 to follow the frequencies of a velocity modulation signal even when the velocity modulation signal has high frequencies. In other words, the velocity modulation current VMI supplied to the VM coils 23a, 23b can follow the velocity modulation signal. Consequently, it is possible to modulate the horizontal scanning speed of an electron beam in a high-frequency region, thereby providing contour correction for an image including a high-frequency component. As a result, an image having a high-frequency component can be precisely displayed.

Throughout the above first to seventh embodiments, the apparatus comprising the luminance signal processing circuit 1, color-difference signal processing circuit 2, RGB matrix circuit 3, CRT drive circuit 4, CRT 5, horizontal deflection circuit 90, vertical deflection circuit 91, horizontal deflection coil 92, and vertical deflection circuit 93 corresponds to an electron beam scanning apparatus; each of the VM coils 20₁ to 20ₙ, 21₁ to 21ₙ, 22a, 22b, 23 corresponds to a velocity modulation coil; and each of the scanning-speed modulation circuit blocks 50, 50₁ to 50ₙ corresponds to a scanning-speed modulation circuit.

Moreover, each of the differentiation circuits 12, 12₁ to 12ₙ, and the first-order differentiation circuit 15₁ to nth-order differentiation circuit 15ₙ corresponds to a differentiation circuit; each of the LPFs 14₁ to 14ₙ corresponds to a low pass filter; the CRT 5 corresponds to a cathode ray tube; each of the horizontal deflection circuit 90 and horizontal deflection coil 92 corresponds to a horizontal deflection device; and each of the vertical deflection circuit 91 and vertical deflection coil 93 corresponds to a vertical deflection device.

Further, the VM coils 22a, 22b correspond to a first and a second velocity modulation coils, respectively; the VM drive circuits 13a, 13b according to the sixth embodiment correspond to a first and a second current supply circuits, respectively; the differentiation circuit 12 corresponds to a signal generation circuit; the VM drive circuit 13 in the scanning-speed modulation circuit block 50 according to the seventh embodiment corresponds to a current supply circuit.

1. A video display apparatus characterized by comprising:
an electron beam scanning apparatus that scans on a screen an electron beam according to an input luminance signal, thereby producing a luminance distribution on the screen for the display of an image;
a plurality of velocity modulation coils provided in said electron beam scanning apparatus, each generating a modulation magnetic field for modulating the scanning speed of said electron beam; and
a plurality of scanning-speed modulation circuits that supply said plurality of velocity modulation coils with currents for modulating the scanning speed, respectively, based on said input luminance signal.

2. The video display apparatus according to claim 1, characterized in that said plurality of velocity modulation coils have the same number of turns.

3. The video display apparatus according to claim 2, characterized in that each of said plurality of scanning-speed modulation circuits includes a differentiation circuit that differentiates said luminance signal.

4. The video display apparatus according to claim 1, characterized in that said plurality of velocity modulation coils have different numbers of turns.

5. The video display apparatus according to claim 4, characterized in that
each of said plurality of scanning-speed modulation circuits includes a differentiation circuit that differentiates said luminance signal;
said differentiation circuits in said plurality of scanning-speed modulation circuits have different differential frequencies; and
said plurality of scanning-speed modulation circuits are connected to said plurality of velocity modulation coils, respectively, such that a differentiation circuit having a lower differential frequency is combined with a velocity modulation coil having a greater number of turns.

6. The video display apparatus according to claim 5, characterized in that
each of said plurality of scanning-speed modulation circuits further includes a low pass filter in a stage prior to said differentiation circuit;
said low pass filters in said plurality of scanning-speed modulation circuits have different cut-off frequencies; and
the cut-off frequency of said low pass filter in each of said plurality of scanning-speed modulation circuits is set such that a low pass filter having a lower cut-off frequency is combined with a differentiation circuit having a lower differential frequency.

7. The video display apparatus according to claim 4, characterized in that
said plurality of scanning-speed modulation circuits include differentiation circuits that perform differentiation of different orders with respect to said respective luminance signals; and
said plurality of scanning-speed modulation circuits are connected to said plurality of velocity modulating circuits, respectively, such that a differentiation circuit that performs lower-order differentiation is combined with a velocity modulation coil having a greater number of turns.

8. The video display apparatus according to claim 1, characterized in that said electron beam scanning apparatus including:
a cathode ray tube;
a horizontal deflection device that deflects an electron beam in said cathode ray tube in the horizontal direction; and
a vertical deflection device that deflects an electron beam in said cathode ray tube in the vertical direction, and
said plurality of velocity modulation coils being arranged so as to modulate the scanning speed of the electron beam in the horizontal direction.

9. A video display apparatus characterized by comprising:
an electron beam scanning apparatus that scans on a screen an electron beam according to an input luminance signal, thereby producing a luminance distribution on the screen for the display of an image;
first and second saddle-type velocity modulation coils provided opposed to each other in said electron beam scanning apparatus, each producing a modulation magnetic field for modulating the scanning speed of said electron beam; and
a scanning-speed modulation circuit that supplies said first and second velocity modulation coils with currents for modulating the scanning speed, respectively, based on said input luminance signal.

10. The video display apparatus according to claim 9 characterized in that said scanning-speed modulation circuit includes:
a signal generation circuit that generates a scanning-speed modulation signal based on said input luminance signal; and
first and second current supply circuits that supply currents for modulating the scanning speed to said first and second velocity modulation coils, respectively, based on said scanning-speed modulation signal generated by said signal generation circuit.

11. The video display apparatus according to claim 9 characterized in that
said first and second velocity modulation coils are connected in parallel with each other, and
said scanning-speed modulation circuit includes:
a signal generation circuit that generates a scanning-speed modulation signal based on said input luminance signal; and
a current supply circuit that supplies said first and second velocity modulation coils with currents for modulating the scanning speed, respectively, based on said scanning-speed modulation signal generated by said signal generation circuit.

12. The video display apparatus according to claim 9 characterized in that said electron beam scanning apparatus includes:
a cathode ray tube;
a horizontal deflection device that deflects an electron beam in said cathode ray tube in the horizontal direction; and
a vertical deflection device that deflects an electron beam in said cathode ray tube in the vertical direction, and
said first and second velocity modulation coils being arranged so as to modulate the scanning speed of the electron beam in the horizontal direction.
